(19) United States
(12) Patent Application Publication
(10) Pub. No.: US 2008/0149074 A1
(43) Pub. Date: Jun. 26, 2008

(54) Fuel supply device

(76) Inventor: Marc Voelker, Marbach (DE)

Correspondence Address: KLAUS J. BACH, 4407 TWIN OAKS DRIVE, MURRYSVILLE, PA, 15668, US

(21) Appl. No.: 12/002,786

(22) Filed: Dec. 18, 2007

Related U.S. Application Data
(63) Continuation-in-part of application No. PCT/EP2006/000578, filed on Jun. 16, 2006.

(30) Foreign Application Priority Data
Jun. 21, 2005 (DE) 10 2005 028 555.4

(51) Int. Cl. F02M 37/14; B60K 15/03

(52) U.S. Cl. 123/511; 220/564

(57) ABSTRACT

In a fuel supply device for the supply of fuel from a fuel tank to an internal combustion engine, with at least one electrically driven fuel pump arranged in the fuel tank which pump conveys fuel out of a fuel tank to the internal combustion engine via a fuel supply line, wherein a fuel line extends from the fuel supply line to a suction jet pump pumping fuel from the fuel tank to a collecting tank in which the electrically driven fuel pump is disposed and wherein a throttle is arranged upstream of the suction jet pump in the fluid line leading to the suction jet pump, a pressure limiting valve is provided upstream of the suction jet pump and downstream of the throttle for limiting the pressure of the fuel operating the suction jet pump thereby reducing or eliminating the noise generated by the suction jet pump.

This is a Continuation-In-Part Application of pending International Patent Application PCT/EP2006/00578 filed 06//16/06 and claiming the priority of German Patent Application 10 2005 028 555.4 filed Jun. 21, 2005.

### BACKGROUND OF THE INVENTION

The invention relates to a fuel supply device for the supply of fuel to an internal combustion engine with at least one electrically operated fuel pump arranged in the fuel tank.

A fuel supply device for an internal combustion engine including a fuel storage tank having a fuel collecting tank disposed therein is disclosed in German patent specification DE 195 04 217 C2. In the fuel storage tank, a fuel pump is provided, which conveys fuel out of the fuel storage tank to the internal combustion engine. The fuel pump is connected to the internal combustion engine via a fuel line. Within the fuel collecting tank, a flow line branches off from the fuel line and extends to a suction jet pump. The suction jet pump pumps fuel into the fuel collecting tank. A delivery valve is provided, in the branch line and upstream of the suction jet pump. A throttle for reducing the pressure at the suction jet pump is arranged between the delivery valve and the suction jet pump.

In the case of high fuel feed quantities, in spite of the pressure-reducing action of the throttle, the fuel pressures in the branch line or at the suction jet pump is relatively high and causes high disturbing noise emissions from the suction jet pump.

It is the object of the present invention to provide a device, by means of which the pressure at the suction jet pump can controllably be reduced and, consequently, the noise emissions from the suction jet pump can be reduced or eliminated.

### SUMMARY OF THE INVENTION

In a fuel supply device for the supply of fuel from a fuel tank to an internal combustion engine, with at least one electrically driven fuel pump arranged in the fuel tank which pump conveys fuel out of a fuel tank to the internal combustion engine via a fuel supply line, wherein a fuel line extends from the fuel supply line to a suction jet pump pumping fuel from the fuel tank to a collecting tank in which the electrically driven fuel pump is disposed and wherein a throttle is arranged upstream of the suction jet pump in the fluid line leading to the suction jet pump, a pressure limiting valve is provided upstream of the suction jet pump and downstream of the throttle for limiting the pressure of the fuel operating the suction jet pump thereby reducing or eliminating the noise generated by the suction jet pump.

The pressure limiting valve is expediently connected to the fuel pressure controller via a connecting line.

In a particular embodiment, the fuel tank has two part regions which are separated from one another by means of a raised wall section. A fuel collection tank and a first suction jet pump are arranged in one part region. In the other part region, a second suction jet pump is provided, which conveys fuel out of the other part region into the fuel collection tank. The second suction jet pump is located in a branch line which branches off from the fuel supply line. The branch-off of the branch line is located downstream of the throttle, upstream of the first suction jet pump and upstream of the pressure limiting valve. The advantage of this is that the pressure can be reduced even at the further suction jet pump.

The invention will become more readily apparent from the following description of particular embodiments of the invention with reference to the accompanying drawings:

### BRIEF DESCRIPTION OF THE DRAWINGS

FIG. 1 shows a diagrammatic illustration of a fuel supply device with one suction jet pump according to a first exemplary embodiment, and

FIG. 2 shows the fuel supply device with two suction jet pumps according to a second exemplary embodiment.

### DESCRIPTION OF PARTICULAR EMBODIMENTS

In the figures, identical or functionally identical components are provided with the same reference symbols.

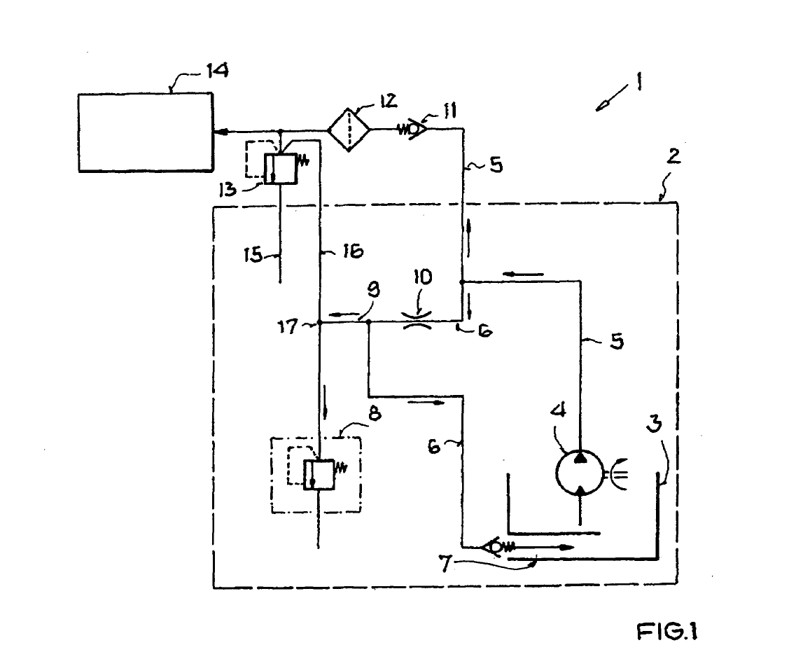

FIG. 1 illustrates a fuel supply device 1 according to the invention with a single suction jet pump 7 according to a first exemplary embodiment. The fuel supply device 1 comprises a fuel tank 2 in which a fuel collection tank 3 is disposed. In the fuel collection tank 3, an electrically driven fuel pump 4 is provided, which pumps fuel to an internal combustion engine 14, that is a gasoline engine or a diesel engine, via a fuel line 5. A fuel filter 12 is provided, upstream of the internal combustion engine 14, in the fuel line 5. The fuel filter 12 serves for removing particles from the fuel. Downstream of the fuel filter 12 and upstream of the internal combustion engine 14, a fuel pressure controller 13 is provided, which regulates the fuel pressure upstream of the internal combustion engine 14 to a specific constant pressure. The fuel pressure controller 13 is connected to the fuel tank 2 via an outflow line 15 such that excess fuel can flow back into the fuel tank 2.

A delivery valve 11 is provided in the fuel supply line 5 outside the fuel tank 2. The delivery valve 11 opens only when the pressure in the fuel supply line 5 is above a threshold value so that return flow of fuel to the fuel tank 3 does not affect the reliability of operation of the internal combustion engine 14 and the supply of fuel to the internal combustion engine 14 is ensured. The delivery valve 11 could also be arranged within the fuel tank 2.

A fuel line 6, in which the suction jet pump 7 is arranged, branches off from the fuel supply line 5 within the fuel tank 2. The suction jet pump 7 pumps fuel into the fuel collection tank 3.

Upstream of the suction jet pump 7, the fuel line 6 has a throttle 10. The throttle 10 limits the volume flow through the flow line 6, so that the pressure in the fuel line 6 downstream of the throttle 10 is lower than the pressure in the fuel line 6 upstream of the throttle 10. The pressure drop achieved by the throttle 10 is not controllable. The pressure in the fuel line 6 upstream of the throttle 10 corresponds to the pressure in the fuel supply line 5.

A control line 9, in which a pressure limiting valve 8 is provided, branches off from the fuel line 6 downstream of the throttle 10 and upstream of the suction jet pump 7. The pressure limiting valve 8 makes it possible to freely select the pressure at the suction jet pump 7. A reference connection of the pressure controller 13 to the control line 9 is established via the connecting line 16. The opening pressure of the pressure controller 13 is thereby influenced by the pressure in the control line 9. Moreover, as a result, the opening pressure of the pressure controller 13 is lower after the fuel pump 4 has been switched off than when the fuel pump 4 is in operation. The connecting line 16 joins the return line 9 at a connection 17.

The pressure as established by the pressure limiting valve 8 prevails in the fuel line 6 downstream of the throttle 10 and upstream of the suction jet pump 7, in the control line 9 and in the connecting line 16. Since the pressure in the region downstream of the throttle 10 is freely selectable, the pressure at the suction jet pump 7 can be further reduced. The high disturbing noise emissions occurring in the case of high system pressures during operation of the internal combustion engine 14 can be reduced or can be completely eliminated by means of the pressure limiting valve 8.

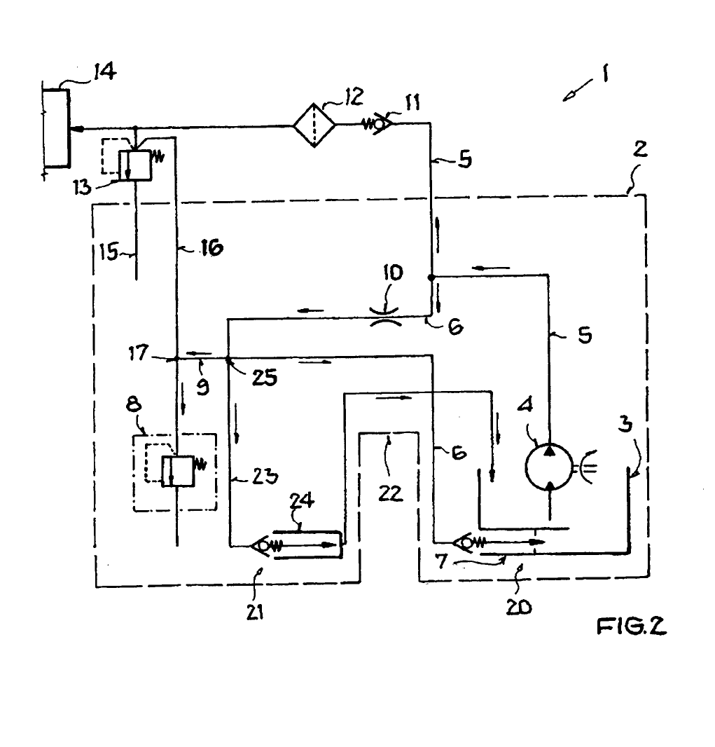

FIG. 2 illustrates a second exemplary embodiment of the fuel supply device according to the invention. The fuel collecting tank 2 has two part regions, a first part region 20 and a second part region 21, which are separated from one another by means of a raised wall section 22. The fuel storage tank 3, with the fuel pump 4, and the suction jet pump 7 are arranged in the first part region 20. A further suction jet pump 24 is provided in the second part region 21 for pumping fuel out of the second part region 21 into the fuel collection tank 3. The further, second suction jet pump 24 is located in a branch line 23 which branches off from the flow line 6 downstream of the throttle 10, upstream of the first suction jet pump 7 and upstream of the pressure limiting valve 8.

As illustrated in FIG. 2, the branch line 23 may branch off from the fuel line 6 at a junction point 25 at which the flow-off line 9 likewise branches off. The branch line 23 could likewise also branch off from the fuel line 6 down-stream of the throttle 10 and upstream of the junction point 25. The branch line 23 could also branch off from the fuel line 6 downstream of the throttle 10 and downstream of the junction point 25. The endpoint 17 of the connecting line 16 could also be the junction point 25.

Numerous variants in the branch-offs of the branch line 23, of the control line 9 and of the connecting line 16 may be implemented. It is in this case important to ensure that all the branch-offs lie downstream of the throttle 10.

What is claimed is:

1. A fuel supply device for supplying fuel to an internal combustion engine (14), comprising: a fuel tank (2), at least one electrically driven fuel pump (4) disposed in the fuel tank (2) for pumping fuel out of the fuel tank (2), a fuel supply line (5) connected to the fuel pump (4) for conducting fuel to the internal combustion engine (14) via the fuel supply line (5), a fuel pressure controller (13) connected to the fuel supply line (5) ahead of the engine (14) and having a fuel return line (15) for returning excess fuel back to the tank (2) so as to maintain the fuel supplied to the engine (14) at a predetermined pressure, a fuel line (6) extending from the fuel supply line (5) to a suction jet pump (7) and including a throttle (10) arranged upstream of the suction jet pump (7), said fuel pump (4) being disposed in a fuel collecting tank (3) arranged in the fuel tank (2) and said suction jet pump (7) being arranged so as to pump fuel from the fuel tank (4) in the collecting tank (3), and a pressure limiting valve (8) connected to the fluid line (6) upstream of the suction jet pump (7) and downstream of the throttle (10) for limiting the pressure of the fuel supplied to the jet pump (7).

2. The fuel supply device as claimed in claim 1, wherein the pressure limiting valve (8) is connected to the fuel pressure controller (13) via a connecting line (16).

3. The fuel supply device as claimed in claim 1, wherein the fuel tank (2) has at least two part regions (20, 21) which are separated from one another by a raised section (22), and the fuel collecting tank (3) and the suction jet pump (7) are arranged in one part region (20), and, in the other part region (21), a further suction jet pump (24) is arranged in the other part region (21) into the fuel collecting tank (3) and, a branch line (23), in which the further suction jet pump (24) is provided, branches off from the flow line (6), downstream of the throttle (10) and upstream of the pressure limiting valve (6), and is connected to the further suction jet pump (24) for operating the suction jet pump (24) for pumping fuel from the other part region (21) of the fuel tank (2) into the collecting tank (3) arranged in the one part region (20).
